(19) United States
(12) Patent Application Publication
(10) Pub. No.: US 2016/0057527 A1
(43) Pub. Date: Feb. 25, 2016

(54) BINAURAL RECORDING SYSTEM AND EARPIECE SET

(71) Applicant: Eears LLC, Brooklyn, NY (US)

(72) Inventor: Anthony Mattana, Brooklyn, NY (US)

(21) Appl. No.: 14/465,057

(22) Filed: Aug. 21, 2014

(51) Int. Cl. H04R 1/10; H04R 1/08

(52) U.S. Cl. CPC H04R 1/1091; H04R 1/08; H04R 2201/401

(57) ABSTRACT

Systems, methods, and sets for capturing and reproducing a binaural recording are provided. In one embodiment, the binaural recording is captured using an earpiece set that includes a pair of earpieces each including a frame, a microphone, and a transducer. The frame is adapted to be worn on an ear, and defines an ear-insertion end and a posterior end opposite the ear-insertion end. The ear-insertion end is adapted to be positioned within an ear canal. The microphone is coupled to the frame for capturing ambient sound, and adapted to be positioned outside the ear canal and substantially coplanar with a tragus of the ear.

### BACKGROUND

Mobile audio recording devices typically use a single mono microphone to record sounds or a pair of coincident microphones that are centrally located. For portability, it may be desirable to reduce the size of such mobile audio recording devices. As the size of the mobile audio recording devices is reduced, however, the microphones may not record realistic sounds.

Binaural recording devices can record or capture sound using two microphones that are arranged as if each microphone were a human ear. The so-captured recording can be subsequently played back to reproduce ambient effects to the listener. For example, the binaural recording can produce a three-dimensional impression of sound.

### SUMMARY

According to one non-limiting aspect of the present disclosure, an example embodiment of a binaural recording system is described. The example binaural recording system includes a pair of earpieces and a non-transitory device operatively coupled to the ear pieces. Each earpiece includes a frame, a microphone, and a transducer. The frame is adapted to be worn on an ear, and defines an ear-insertion end and a posterior end opposite the ear-insertion end. The ear-insertion end is adapted to be positioned within an ear canal. The microphone is coupled to the frame for capturing ambient sound, and adapted to be positioned outside the ear canal and substantially coplanar with a tragus of the ear. The transducer is coupled to the ear-insertion end of the frame, and configured to reproduce an incoming sound signal. At least one earpiece includes a wireless transmitter coupled to the posterior end of the frame. The wireless transmitter is configured to transmit outgoing data representative of the ambient sound and receive incoming data representative of the incoming sound signal. At least one earpiece includes a power supply electrically coupled to the microphones, the transducers, and the wireless transmitter. The non-transitory device has instructions stored thereon that are configured when executed to selectively operate the microphones and the transducers of the earpieces.

According to another non-limiting aspect of the present disclosure, an example embodiment of an earpiece set is described. The example earpiece set includes a pair of earpieces each including a frame, a microphone, and a transducer. The frame is adapted to be worn on an ear, and defines an ear-insertion end and a posterior end opposite the ear-insertion end. The ear-insertion end is adapted to be positioned within an ear canal. The microphone is coupled to the frame for capturing ambient sound, and adapted to be positioned outside the ear canal and substantially coplanar with a tragus of the ear. The transducer is coupled to the ear-insertion end of the frame, and configured to reproduce an incoming sound signal. At least one earpiece includes a wireless transmitter coupled to the posterior end of the frame. The wireless transmitter is configured to transmit outgoing data representative of the ambient sound and receive incoming data representative of the incoming sound signal. At least one earpiece includes a power supply electrically coupled to the microphones, the transducers, and the wireless transmitter.

According to another non-limiting aspect of the present disclosure, a method for creating a binaural recording is provided. The method includes prompting a user, via a processor, to select a recording option on a touchscreen of a recorder, the recording option selected from the group consisting of recording audio, recording audio and video, broadcasting audio, and broadcasting audio and video. At least one gesture is received from the user on the touchscreen. The selected recording option is determined via the processor. The creation of at least one binaural recording using an earpiece set is caused via the processor. The earpiece set includes a pair of earpieces each including a frame, a microphone, and a transducer. The frame is adapted to be worn on an ear, and defines an ear-insertion end and a posterior end opposite the ear-insertion end. The ear-insertion end is adapted to be positioned within an ear canal. The microphone is coupled to the frame for capturing ambient sound, and adapted to be positioned outside the ear canal and substantially coplanar with a tragus of the ear. The transducer is coupled to the ear-insertion end of the frame, and configured to reproduce an incoming sound signal. At least one earpiece includes a wireless transmitter coupled to the posterior end of the frame. The wireless transmitter is configured to transmit outgoing data representative of the ambient sound and receive incoming data representative of the incoming sound signal. At least one earpiece includes a power supply electrically coupled to the microphones, the transducers, and the wireless transmitter.

According to another non-limiting aspect of the present disclosure, a method for communicating a binaural recording is provided. The method comprises receiving, at a server, a binaural recording created via a binaural recording system comprising a pair of earpieces each including a frame, a microphone, and a transducer, the frame adapted to be worn on an ear, the frame defining an ear-insertion end and a posterior end opposite the ear-insertion end, the ear-insertion end adapted to be positioned within an ear canal, the microphone coupled to the frame for capturing ambient sound, the microphone adapted to be positioned outside the ear canal and substantially coplanar with a tragus of the ear, the transducer coupled to the ear-insertion end of the frame, and the transducer configured to reproduce an incoming sound signal, at least one earpiece including a wireless transmitter coupled to the posterior end of the frame, the wireless transmitter configured to transmit outgoing data representative of the ambient sound and receive incoming data representative of the incoming sound signal, and at least one earpiece including a power supply electrically coupled to the microphones, the transducers, and the wireless transmitter, and a non-transitory device operatively coupled to the earpieces and having instructions thereon that are configured when executed to selectively operate the microphones and the transducers of the earpieces. A user election is received for transmission selected from the group consisting of transmitting the binaural recording to a user device, transmitting the binaural recording via email, and transmitting the binaural recording to a third-party service provider. Responsive to the user election, the binaural recording is transmitted.

Additional features and advantages are described herein, and will be apparent from the following Detailed Description and the figures.

### BRIEF DESCRIPTION OF THE DRAWING

Features and advantages of the systems and earpiece sets described herein may be better understood by reference to the accompanying drawings in which:

FIG. 1 is a front view of a non-limiting embodiment of an earpiece set according to the present disclosure, illustrating a frame, a microphone, and a transducer in relation to a user's ear.

FIG. 2 is a side view of the earpiece set of FIG. 1

FIG. 3 is an enlarged front view of the earpiece set of FIG. 1.

FIG. 4 is an enlarged partial side view of the earpiece set of FIG. 1, illustrating the microphone and the transducer concentrically located relative to each other.

FIG. 5 is a cutaway view of the earpiece set of FIG. 1.

FIG. 6 is a schematic illustration of a non-limiting embodiment of a binaural recording system according to the present disclosure.

FIG. 7 is an enlarged partial schematic illustration of the binaural recording system of FIG. 6.

FIG. 8 is a flow chart of a user recording using the binaural recording system of FIG. 6.

FIG. 9 shows a flow chart of a user listening using the binaural recording system of FIG. 6.

FIGS. 10-11 show examples of a user interface for the binaural recording system of FIG. 6.

The reader will appreciate the foregoing details, as well as others, upon considering the following detailed description of certain non-limiting embodiments of systems and earpiece sets according to the present disclosure. The reader may also comprehend certain of such additional details upon using the systems and earpiece sets described herein.

### DETAILED DESCRIPTION

Capturing a suitable binaural recording substantially without augmentation or attenuation relative to the ambient sound can be complex and cumbersome. In particular, depending on the position of the earpiece set on a user's ears, the captured recording may introduce distortion relative to the ambient sound. For example, if a binaural recording is captured using microphones positioned within the ear canals of a user, lower frequencies may be undesirably augmented. On the other hand, if a binaural recording is captured using a microphone positioned substantially outside the ear canals of a user, the recording may not sufficiently reproduce ambient effects to the listener. Thus, there has developed a need for systems and earpiece sets for capturing a suitable binaural recording that are made of a simple construction and are user-friendly.

The present disclosure, in part, is directed to systems and earpiece sets for capturing and reproducing a binaural recording. The binaural recording is captured using an earpiece set that includes a pair of earpieces each including a frame, a microphone, and a transducer. The frame is adapted to be worn on an ear, and defines an ear-insertion end and a posterior end opposite the ear-insertion end. The ear-insertion end is adapted to be positioned within an ear canal. The microphone is coupled to the frame for capturing ambient sound, and adapted to be positioned outside the ear canal and substantially coplanar with a tragus of the ear. This positioning of the microphone can facilitate capturing a suitable binaural recording substantially without augmentation or attenuation relative to the ambient sound. For example, the sound that is captured by the so-positioned microphone can be acoustically identical to the ambient sound that would enter the user's ear naturally.

By capturing sound that is acoustically identical to the ambient sound, the quality of the sound recording is enhanced to provide a three-dimensional impression for the listener, as if the listener were present when and where the recording took place. In one non-limiting example, the so-captured recording can provide an impression such that one can travel back in time to relive one's favorite concert again and again. In another non-limiting example, the visceral soundscape of a political protest may be captured vividly enough to present as evidence in a court of law. In yet another non-limiting example, the so-captured recording can provide an impression to a grandparent, who is hundreds of miles away, so as to feel like being right there in the room with the grandchild. In this regard, the systems and earpiece sets according to the present disclosure can be versatile for acoustics in various contexts.

A “binaural recording” as used herein includes definitions that are generally known in the relevant art, and can refer to sound recorded or captured using two microphones that are arranged as if each microphone were a human ear.

An “ear canal” as used herein includes definitions that are generally known in the relevant art, and can refer to the hole where sound enters the ear; the rest of the ear functions as way to collect ambient sound waves from the surroundings.

An “ambient sound” as used herein includes definitions that are generally known in the relevant art, and can refer to the sound generated from a plurality of sources in the environment surrounding a user. For example, if the user is attending a concert, the ambient sound would be the music from the concert. Additionally, if the user is at home playing with the user's children, the ambient sound would be the noise the child makes. In another example, if the user is at a baseball game, the ambient sound could be the sound of thousands of fans cheering when a grand slam is hit.

### Earpiece Set

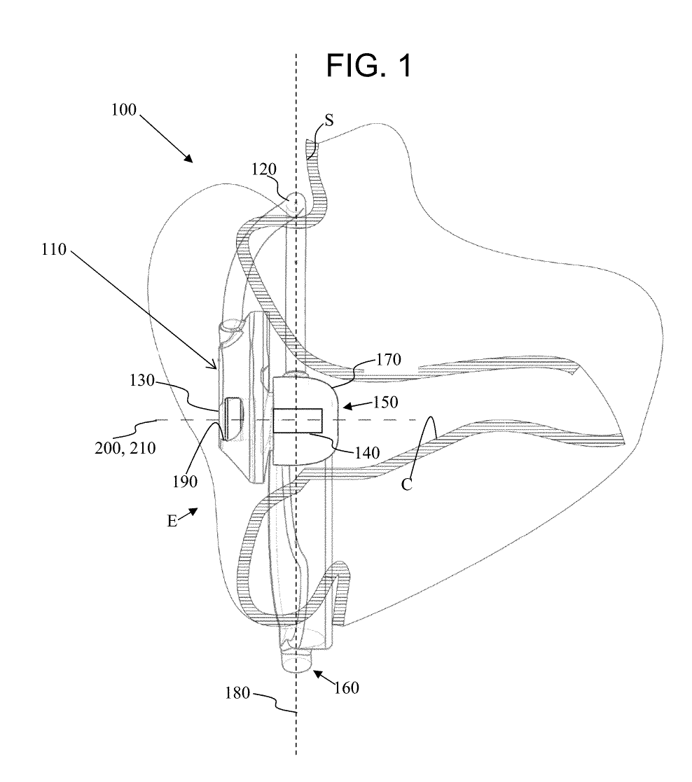

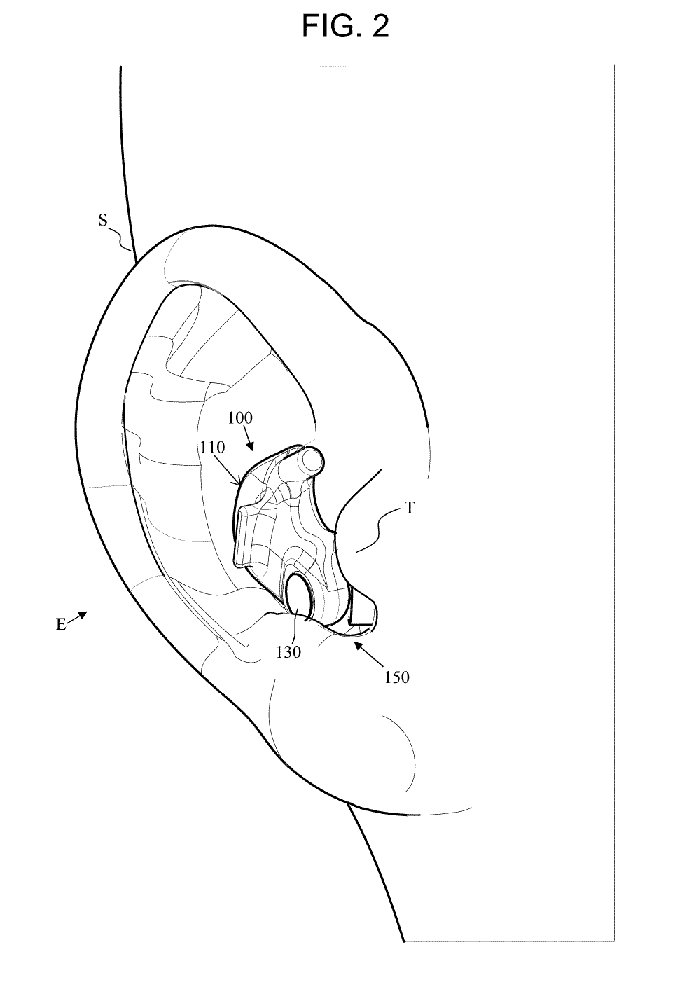

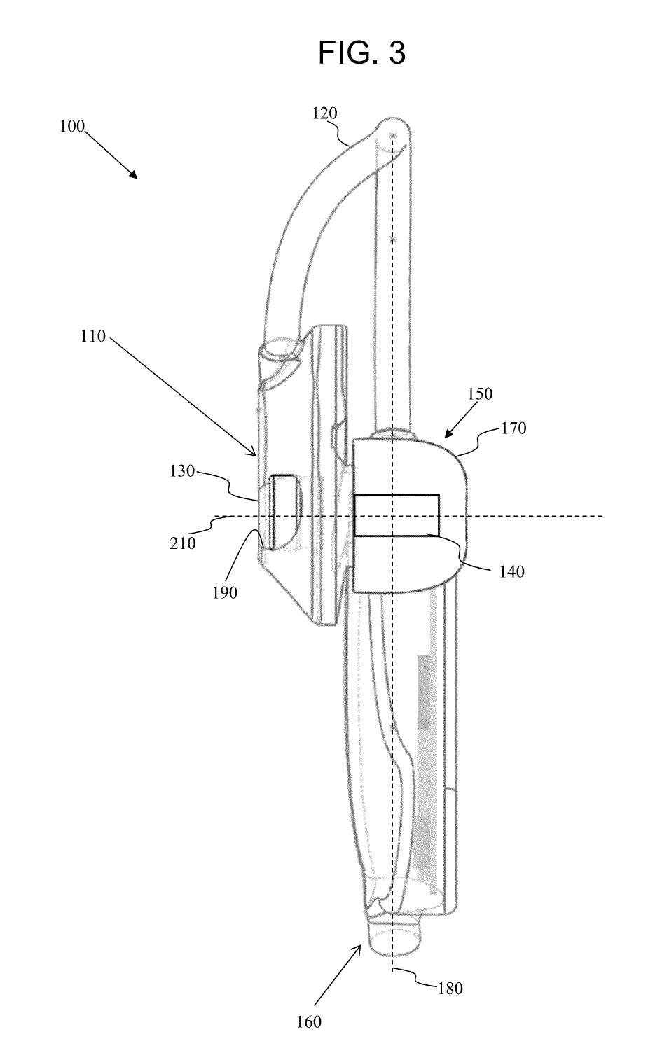

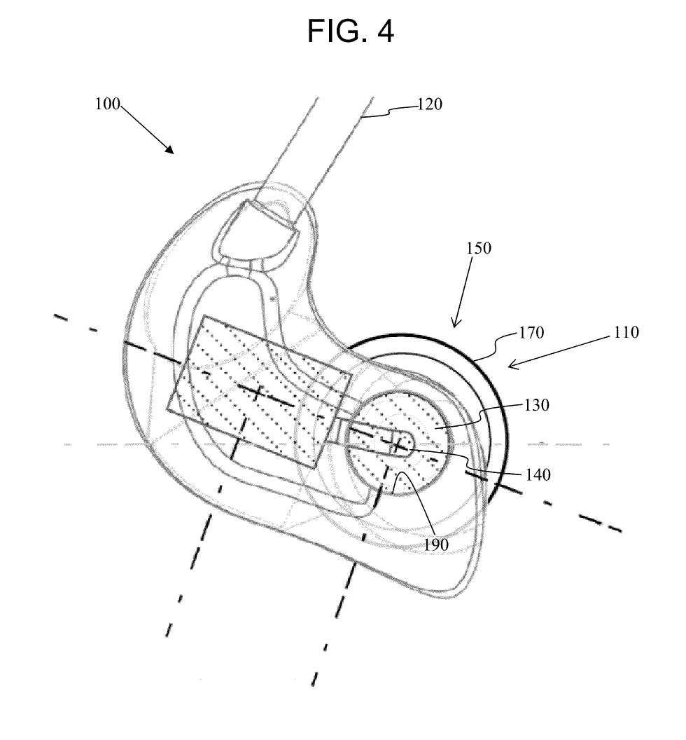

Referring to FIGS. 1-4, the illustrated earpiece set 100 includes a pair of earpieces 110. For the purposes of the description, the configuration of each earpiece 110 is generally the same, and will be described with reference to the illustrated earpiece 110 with the same effect as to the other earpiece (not shown). In certain non-limiting embodiments, the earpiece 110 can be made of plastic or similar light weight material allowing for comfortable wear by the user over the user's ear. In other embodiments, the earpiece 110 can be made of metal or similar strong material providing for enhanced strength and rigidity of the earpiece 110. In further embodiments, any material known in the art with similar characteristics can be used to produce the earpiece 110.

With continuing reference to FIGS. 1-3, the earpiece 110 includes a frame 120, a microphone 130, and a transducer 140. The frame 120 is adapted to be worn on an ear E, and defines an ear-insertion end 150 and a posterior end 160 opposite the ear-insertion end 150. The ear-insertion end 150 is adapted to be positioned within an ear canal C. In certain non-limiting embodiments, the frame 120 of the earpiece 110 can be curved, extending over the top of a user's ear E and resting on the top portion of the user's ear E, between the helix and the skull S. Positioning the frame 120 over the top of the user's ear E between the helix and the skull S can allow the ear insertion end 150 to be located at a suitable location for capturing a binaural recording, as further explained below.

In certain non-limiting embodiments, a pair of deformable bodies 170 can be respectively coupled to the ear-insertion end 150 of the frame 120. The deformable bodies 170 can be adapted to substantially seal the respective ear canal C. For example, sealing of the ear canal can be with respect to sound waves, allowing for optimal playback of recorded sound through the earpieces, as further explained below. In further embodiments, sealing of the ear canal C can seal out water from the ear canal C, thereby protecting the ear canal C and the inner ear from water, for example, when it rains. The deformable bodies 170 can be made of a material allowing for the desired advantage. In other embodiments, the ear insertion end 150 can be made of a hard material, allowing for a more protected encasement of the electronic components located within the ear insertion end 150.

Still referring to FIGS. 1-4, the microphone 130 is coupled to the frame 120 for capturing ambient sound, and adapted to be positioned outside the ear canal C and substantially coplanar with a tragus T of the ear E. The placement of the microphone 130 coplanar with the tragus T can allow the ambient sound that is captured by the microphone 130 to be acoustically identical to the ambient sound that would enter the user's ear E naturally. For example, by capturing this acoustically identical sound, the quality of the sound recording is enhanced to allow subsequent playback of the sound to be the same as if the person subsequently hearing the recorded sound had been present and in the same location as the original recording. The microphone 130 can include any suitable electronic sound capturing devices.

In certain non-limiting embodiments, a respective pair of the transducer 140 and the posterior end 160 of the frame 120 defines a common plane 180, and the microphone 130 is spaced apart from the common plane 180. In other embodiments, the microphone 130 can be located substantially coplanar with the common plane 180, provided the microphone 130 is positioned outside the ear canal C and substantially coplanar with the tragus T of the ear E.

In certain non-limiting embodiments, each microphone 130 is respectively housed in an opening 190 within the frame 120. Depending on the usage requirements or preferences for the particular microphone 130, an opening 190 having a shape that mirrors the shape of the ear canal C, e.g. substantially cylindrical, can provide an acoustical advantage. In certain non-limiting embodiments, each ear canal C respectively defines a first longitudinal axis 200, and each substantially cylindrical opening 190 respectively defines a second longitudinal axis 210 extending substantially parallel to the first longitudinal axis 200. In further embodiments, each microphone 130 respectively covers at least a part of the transducer 140 when viewed along the second longitudinal axis 210. In other embodiments, the opening 190 can be any other shape necessary to fit the microphone within the housing and allowing for the passage of sound waves from the outside environment into the microphone 130. For example, a rectangular opening may provide for easier substitution of different microphones 130.

In certain non-limiting embodiments, the opening 190 can point in substantially the same direction as the ear canal C. In this regard, if a first vector were to point in the direction of the ear canal C, a second vector pointing in the direction of the opening 190 extends parallel to the first vector. Depending on the usage requirements or preferences for the particular microphone 130, the alignment of these two vectors can ensure that the microphone 130 is pointed in the most acoustically accurate direction for capturing ambient sound waves.

In certain non-limiting embodiments, the ambient sound defines amplitudes having frequency characteristics, and the microphones 130 are positioned such that the outgoing data represents frequency response characteristics substantially without augmentation or attenuation relative to the frequency characteristics of the ambient sound from approximately 20 Hz to approximately 20 kHz. However, in other embodiments, other frequency ranges may also be targeted by adjusting the microphone 130.

In certain non-limiting embodiments, each microphone 130 is fixedly coupled to a respective frame 120. By fixedly coupling the microphone 130 to the frame 120, the microphone 130 can stay electrically connected to the rest of the components in a simple construction. In other embodiments, however, the microphone 130 can be removably coupled to the frame 120, allowing for the removal and replacement of the microphone 130.

With continuing reference to FIGS. 1-4, the transducer 140 is coupled to the ear-insertion end 150 of the frame 120, and configured to reproduce an incoming sound signal. In certain non-limiting embodiments, the transducer 140 can be configured to receive electrical signals and transform the signals into sound waves or to receive sound waves and transform the sound waves into electrical signals. When the transducer 140 is configured to receive electrical signals and transform the signals into sound waves, the transducer 140 acts similar to an in-ear speaker, providing sound play-back for the user. That is, the transducer 140 can be used for subsequent play-back of sound that was originally recorded with the microphone 130, as further explained below.

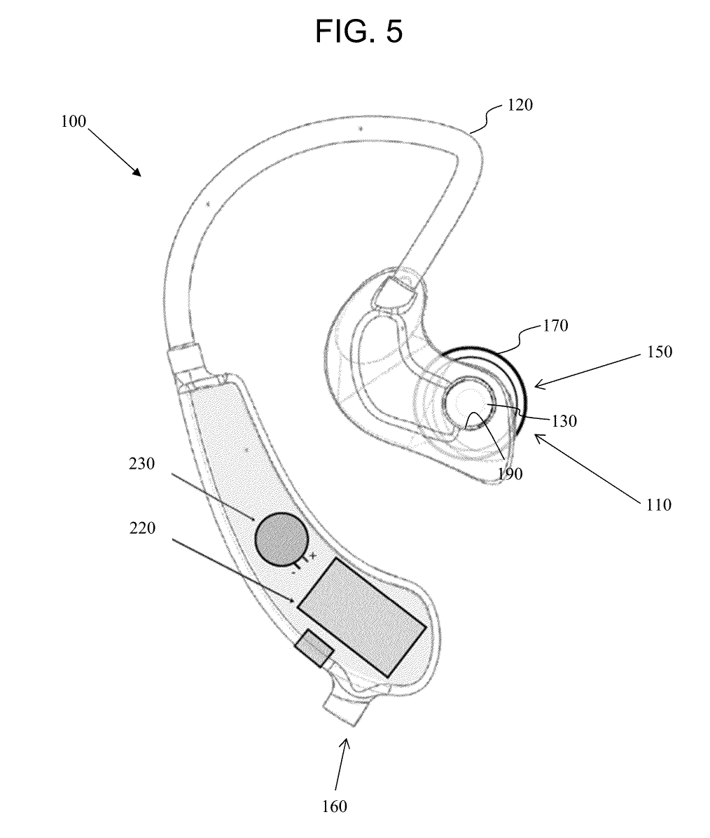

Referring to FIG. 5, in the illustrated embodiment, each earpiece 110 includes a wireless transmitter 220 coupled to the posterior end 160 of the frame 120. In other embodiments, one earpiece 110 may include a wireless transmitter 220 coupled to the posterior end 160 of the frame 120, and the other earpiece may not include the wireless transmitter 220. The wireless transmitter 220 allows for two-way communication. In this regard, the wireless transmitter 220 is configured to transmit outgoing data representative of the ambient sound and receive incoming data representative of the incoming sound signal. For example, the incoming and outgoing data can be sound signals stored for each stereo channel in a Waveform Audio File Format (“WAY”), an AC-3 format, an advanced audio coding (“AAC”) format, an MP3 format, or any other audio file. In certain non-limiting embodiments, the outgoing data corresponds directly to the captured sound substantially without any augmentation or attenuation. However, in other embodiments, the outgoing data may be augmented, attenuated or tuned.

In certain non-limiting embodiments, the transmitted data can also be configured to be other signals necessary for the connection and operation of the earpieces 110. For example, other transmitted data could include a wireless charging signal for the earpiece 110, or similar signals. In certain non-limiting embodiments, the wireless transmitter 220 can be configured to comply with existing transmission protocols such as a Bluetooth compatible protocol, IEEE 802.11 or similar short and medium range wireless transmission protocols. In other embodiments, the wireless transmitter 220 may use any other suitable form of short or medium range wireless communication.

With continuing reference to FIG. 5, in the illustrated embodiment, each earpiece 110 includes a power supply 230 electrically coupled to the respective microphone 130, transducer 140, and wireless transmitter 220. In other embodiments, one earpiece 110 may include a power supply 230 electrically coupled to the microphones 130, transducers 140, and wireless transmitters 220, and the other earpiece may not include the power supply 230. In further embodiments, the wireless transmitter 220 and/or the power supply 230 can be positioned away from the earpieces 110, for example at the back of a user's head, and shared between the earpieces 110.

In certain non-limiting embodiments, the power supply 230 can be a battery housed in a respective frame 120. A battery could be advantageous for the small, lightweight and portable aspects associated with a battery. In other embodiments, the power supply 230 may be attached or connected to the earpiece 110 outside a respective frame 120. For example, a cord (not shown) may attach the earpiece 110 to an external power supply 230. An external power supply 230 can be advantageous, as it allows for access to a larger power supply. In other embodiments, any other suitable power supplies known in the art may be used. In certain non-limiting embodiments, the coupling between the power supply 230 and the earpiece 110 is accomplished through wires connecting the components, circuitry or other similar electrical connections. In further embodiments, the posterior end 160 contains a charging location to allow for the recharge of the power supply 230.

### Binaural Recording System

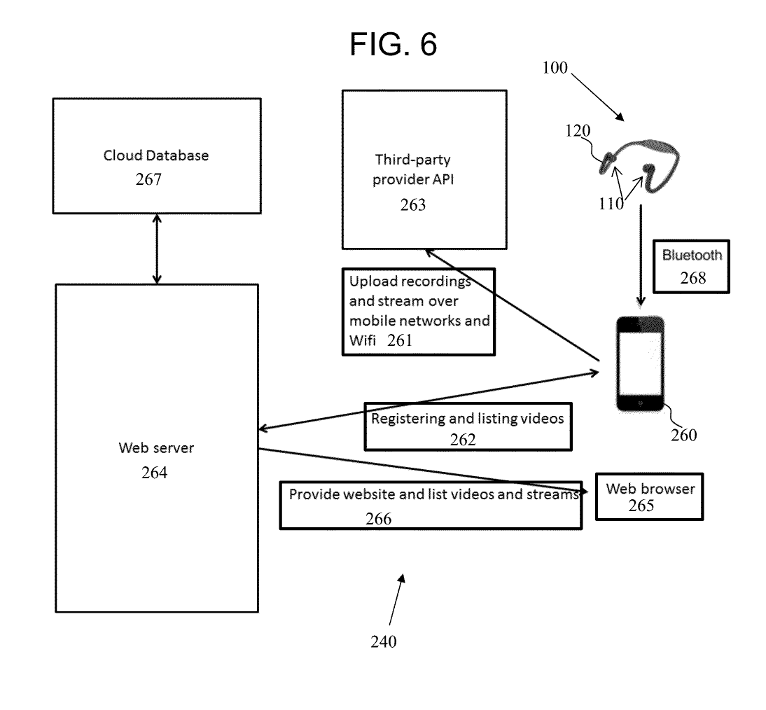

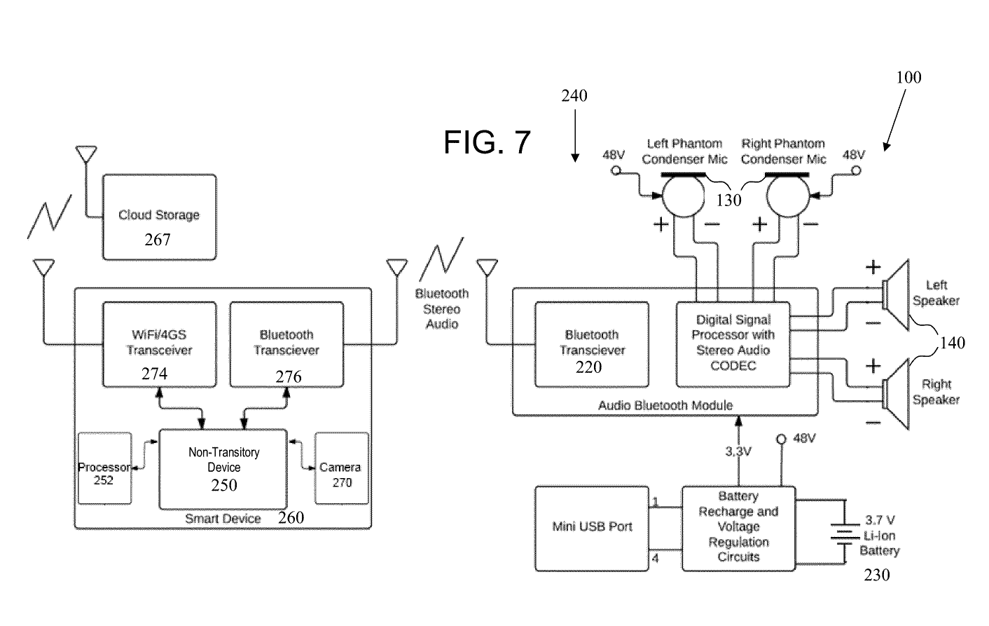

FIGS. 6-7 illustrate the binaural recording system 240 according to another embodiment of the invention. The binaural recording system 240 includes a pair of earpieces 110 and a non-transitory device or computing memory 250 operatively coupled to the earpieces 110. The non-transitory device 250 has instructions stored thereon that are configured when executed to selectively operate the microphones 130 and the transducers 140 of the earpieces 110, e.g., allowing for the recording and play back of sound signals. In certain non-limiting embodiments, the non-transitory device 250 has instructions for the earpieces 110 that include start recording commands, stop recording commands, transfer commands, play commands, pause commands, stop commands, volume commands, and other control commands necessary for the operation of the earpiece 110.

In certain non-limiting embodiments, the binaural recording system 240 includes a recorder or receiving device 260 operatively coupled to the earpieces 110 and the non-transitory device 250, and a program stored on the non-transitory device 250, including instructions for recording the ambient sound from each earpiece 110 into a respective audio channel. The recorder 260 can be a smart device such as a smart phone, a smart eyewear, a smart watch, a tablet, a laptop or any other electronic device so long as it has a non-transitory device 250 and a processor 252. A cellular phone can be desirable when a user is interested in the portability of the system. On the other hand, a laptop can be desirable for the enhanced computing power, allowing for analysis and sharing of the electronic signals and larger storage capacity, which in turn can allow for higher quality and greater volume of storage.

In certain non-limiting embodiments, the binaural recording system 240 includes a camera 270 operatively coupled to the non-transitory device 250 in addition to the earpieces 110 for binaural recording. For example, the camera 270 can be any camera containing a 3.5-mm female stereo microphone jack, such as a GoPro® camera or any other suitable digital camera. The earpiece set 100 can include a female 3.5-mm female jack (not shown) that can connect to the camera 270 via a male-to-male 3.5-mm stereo cable (not shown). In another example, the camera 270 can be a three-dimensional stereoscopic imaging apparatus for realistically capturing or recording a video signal. The program stored on the non-transitory device 250 may match the video signal with the audio signal captured by the microphone 130 and allow for the simultaneous playback, or combination of the two signals into one stereo file. In certain non-limiting embodiments, the program includes instructions to determine a command selected from the group consisting of recording only the ambient sound, recording the ambient sound and the video signal, live-streaming only the ambient sound, and live-streaming the ambient sound and the video signal.

In certain non-limiting embodiments, the binaural recording system 240 uses an application programmable interface (“API”) to upload and/or stream recordings over mobile networks and Wi-Fi (block 261), and register and list audios and/or videos (block 262). In this regard, the recorder 260 can be used to communicate with a third-party provider API 263 and/or web servers 264 managed by respective entities. In certain non-limiting embodiments, a user can access the web server 264 via a web browser 265, and the web server 264 can provide a searchable web form or web page listing the audios and/or videos and streams (block 266) that are received from the recorder 260. The web server 264 can include a single server, or alternatively, can be distributed among multiple servers and/or within a cloud computing framework 267.

### User Interface

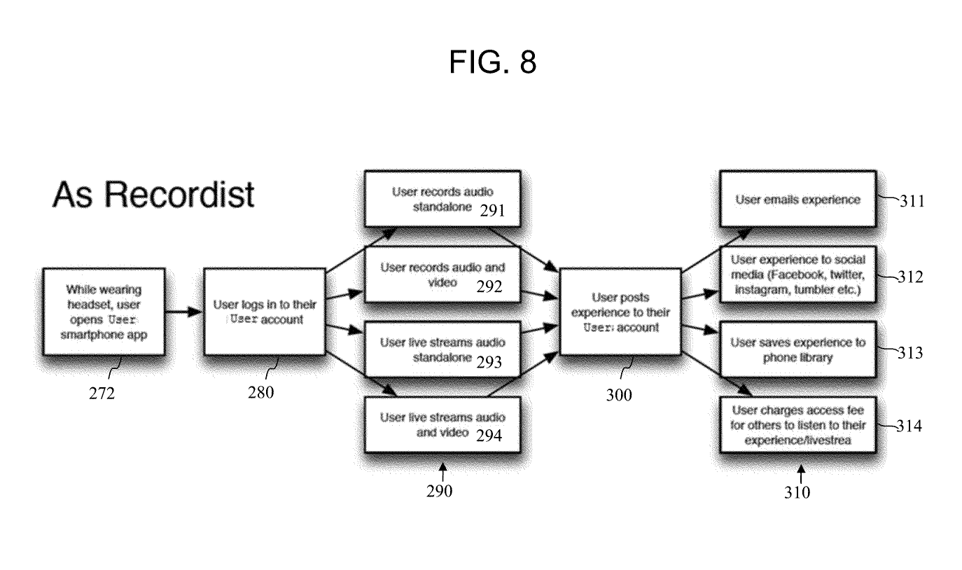

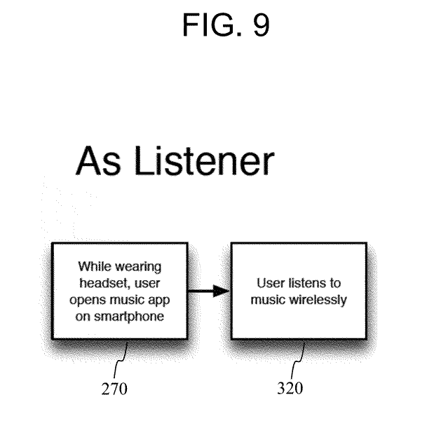

Also referring to FIGS. 8-9, the recorder 260 is configured to select between at least a recording mode and a playback mode, as well as provide for the collection and storage of data corresponding to at least sound recordings. In the recording mode, a user, while wearing at least one earpiece 110, opens an application user interface or program on the recorder 260 (block 272). The user interface can be an application (“App”) operating on the recorder 260.

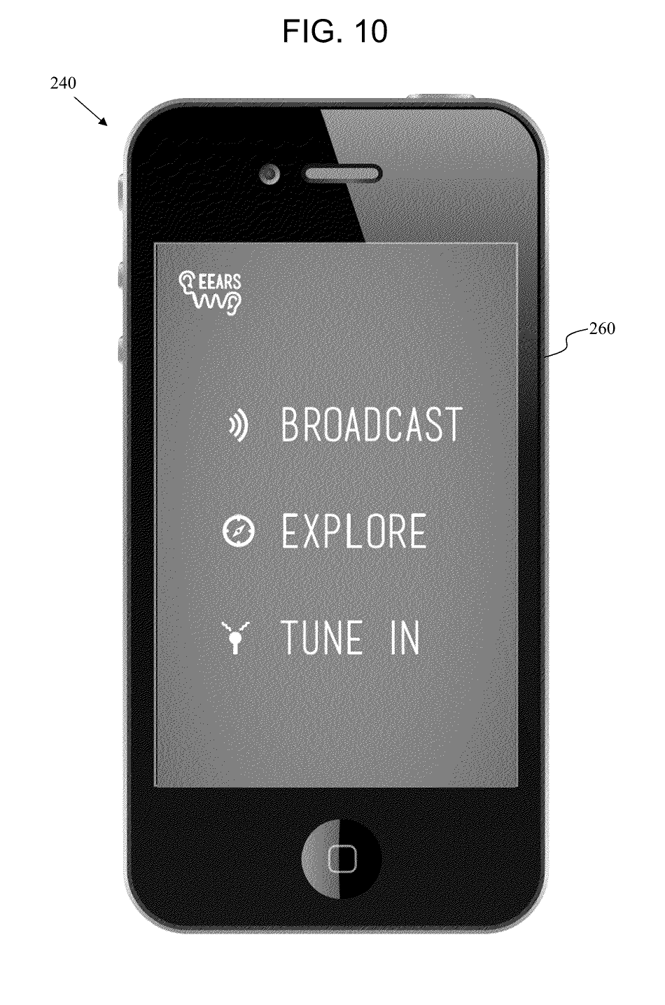

Next, the user logs into a user account (block 280). FIG. 10 includes a screenshot of a non-limiting embodiment of the user interface. It should be appreciated that the user interface may be modified in appearance and/or function based upon the configuration of the binaural recording system 240.

In block 290, for creating a binaural recording, a user is prompted, via the processor 252, to select a recording option on a touchscreen of the recorder 260. The user can select a variety of recording options, including, but not limited to: recording audio with the earpiece 110 microphone 130 (block 291), recording audio with the earpiece 110 microphone 130 and video with the recorder 260 camera (block 292), streaming or broadcasting audio with the earpiece 110 microphone 130 (block 293), and streaming or broadcasting audio with the earpiece 110 microphone 130 and video from the recorder 260 (block 294). At least one gesture is received from the user on the touchscreen. In certain non-limiting embodiments, the gesture can include one or more finger contacts or taps, one or more swipes (from left to right, right to left, upward and/or downward) and/or a rolling of a finger (from right to left, left to right, upward and/or downward). The selected recording option is determined via the processor 252. The creation of at least one binaural recording using the earpiece set 100 is then caused via the processor 252, and the wireless transmitter 220 can transmit electrical signals (see FIG. 6, block 268) from the earpiece 110 to the recorder 260 representative of sound signal.

If the user elects to record, the recording can be saved in the user account (block 300). In certain non-limiting embodiments, after block 300, recordings can be emailed (block 311), shared with social media (block 312), saved in the library on the recorder 260 (block 313), or the user could charge a fee for others to listen to the stream or recordings (block 314). In further embodiments, a user can transmit the recordings to a third-party service provider (e.g., post to a Facebook® wall, pin to Pinterest®, or post to a Twitter, Instagram, or Tumblr account). In still further embodiments, a message server may be configured to parse notifications or alerts to notify or alert users of recordings in the form of instant messages, text messages (e.g., SMS, MMS), or web forum messages. The program can also allow users to upload, via a compatible transmission protocol such as Wi-Fi or 4G that may be included in the recorder 260, their recordings to their cloud storage or a similar networked data storage option.

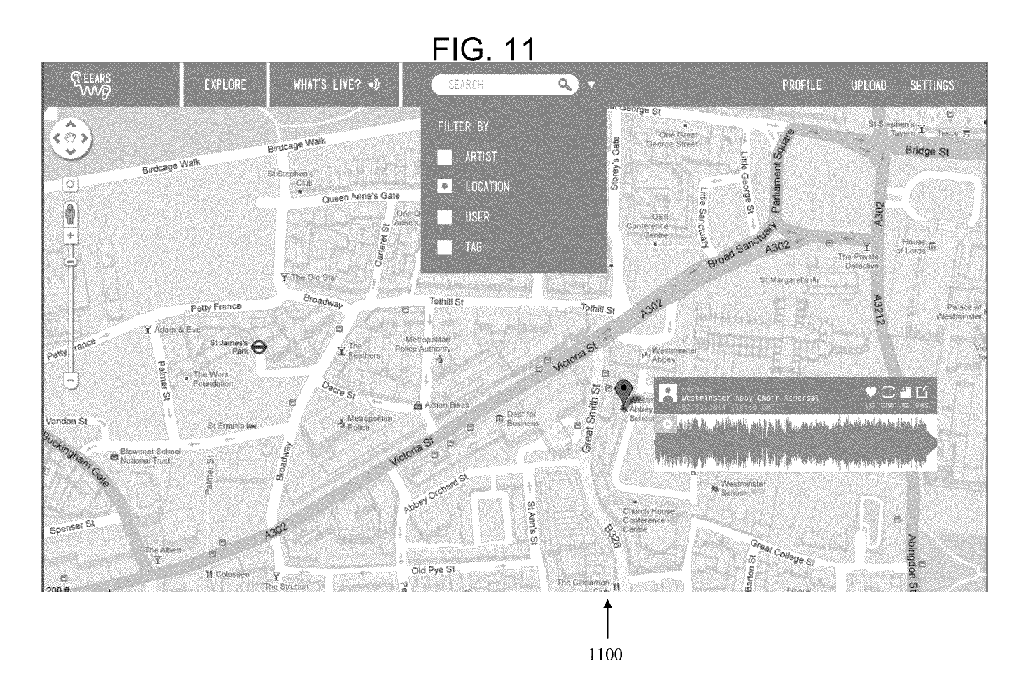

As one example, FIG. 11 is a screenshot of a non-limiting embodiment of the user interface 1100 illustrating a location where the recording was captured. In certain non-limiting embodiments, the user interface can also be configured for including a GPS location of the earpiece 110, or including metadata associated with the recorded ambient sound, such as song title, people or artists who made the recorded song, and people tagged as having been present when and where the recording took place.

If the user elects to stream, the recording can be streamed using the user account. When a streaming command is issued, the program can connect to or activate a data network via a Wi-Fi or 4G transceiver 274 or Bluetooth transceiver 276 that may be included in the recorder 260, allowing for real-time, or substantially real-time, transmission of the live recording to anyone accessing the network with a compatible program on their own device. The program can stream either video, sound or a combination of both video and sound.

Referring to FIG. 9, to utilize the play-back capabilities, the user, while wearing at least one earpiece 110, opens the program on the recorder 260 (block 272). The user then selects the music file or program to be played, and the recorder 260 sends a wireless signal to the earpiece 110. The wireless transmitter 220 of the earpiece 110 can receive signals corresponding to musical play-back from the recorder 260. The transducer 140 can be used to transform an electric signal into a sound wave for play-back of the sound signal being transmitted. The user can then listen to the file or program through the earpiece 110 (block 320).

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A binaural recording system comprising:
a pair of earpieces each including a frame, a microphone, and a transducer, the frame adapted to be worn on an ear, the frame defining an ear-insertion end and a posterior end opposite the ear-insertion end, the ear-insertion end adapted to be positioned within an ear canal, the microphone coupled to the frame for capturing ambient sound, the microphone adapted to be positioned outside the ear canal and substantially coplanar with a tragus of the ear, the transducer coupled to the ear-insertion end of the frame, and the transducer configured to reproduce an incoming sound signal, at least one earpiece including a wireless transmitter coupled to the posterior end of the frame, the wireless transmitter configured to transmit outgoing data representative of the ambient sound and receive incoming data representative of the incoming sound signal, and at least one earpiece including a power supply electrically coupled to the microphones, the transducers, and the wireless transmitter; and
a non-transitory device operatively coupled to the earpieces and having instructions thereon that are configured when executed to selectively operate the microphones and the transducers of the earpieces.

2. The binaural recording system of claim 1, wherein a respective pair of the transducer and the posterior end of the frame defines a common plane, and wherein each microphone is spaced apart from the common plane.

3. The binaural recording system of claim 1, wherein each microphone is respectively housed in a substantially cylindrical opening within the frame.

4. The binaural recording system of claim 3, wherein each ear canal respectively defines a first longitudinal axis, and each substantially cylindrical opening respectively defines a second longitudinal axis extending substantially parallel to the first longitudinal axis.

5. The binaural recording system of claim 4, wherein each microphone respectively covers at least a part of the transducer when viewed along the second longitudinal axis.

6. The binaural recording system of claim 1, wherein the ambient sound defines amplitudes having frequency characteristics, and wherein the microphones are positioned such that the outgoing data represents frequency response characteristics substantially without augmentation or attenuation relative to the frequency characteristics of the ambient sound from approximately 20 Hz to approximately 20 kHz.

7. The binaural recording system of claim 1, wherein each microphone is fixedly coupled to a respective frame.

8. The binaural recording system of claim 1 further comprising a pair of deformable bodies respectively coupled to the ear-insertion end of the frame, the deformable bodies adapted to substantially seal the respective ear canal.

9. The binaural recording system of claim 1, wherein the power supply is housed in a respective frame.

10. The binaural recording system of claim 1 further comprising a recorder operatively coupled to the earpieces and the non-transitory device, wherein the non-transitory device further has instructions stored thereon that are configured when executed to record the ambient sound from each earpiece into a respective audio channel.

11. The binaural recording system of claim 10 further comprising a camera operatively coupled to the non-transitory device, wherein the non-transitory device further has instructions stored thereon that are configured when executed to record a video signal.

12. The binaural recording system of claim 11, wherein the non-transitory device further has instructions stored thereon that are configured when executed to determine a command selected from the group consisting of recording only the ambient sound, recording the ambient sound and the video signal, live-streaming only the ambient sound, and live-streaming the ambient sound and the video signal.

13. An earpiece set comprising:
a pair of earpieces each including a frame, a microphone, and a transducer, the frame adapted to be worn on an ear, the frame defining an ear-insertion end and a posterior end opposite the ear-insertion end, the ear-insertion end adapted to be positioned within an ear canal, the microphone coupled to the frame for capturing ambient sound, the microphone adapted to be positioned outside the ear canal and substantially coplanar with a tragus of the ear, the transducer coupled to the ear-insertion end of the frame, and the transducer configured to reproduce an incoming sound signal, at least one earpiece including a wireless transmitter coupled to the posterior end of the frame, the wireless transmitter configured to transmit outgoing data representative of the ambient sound and receive incoming data representative of the incoming sound signal, and at least one earpiece including a power supply electrically coupled to the microphones, the transducers, and the wireless transmitter.

14. The earpiece set of claim 13, wherein a respective pair of the transducer and the posterior end of the frame defines a common plane, and wherein each microphone is spaced apart from the common plane.

15. The earpiece set of claim 13, wherein each microphone is respectively housed in a substantially cylindrical opening within the frame.

16. The earpiece set of claim 15, wherein each ear canal respectively defines a first longitudinal axis, and each substantially cylindrical opening respectively defines a second longitudinal axis extending substantially parallel to the first longitudinal axis.

17. The earpiece set of claim 16, wherein each microphone respectively covers at least a part of the transducer when viewed along the second longitudinal axis.

18. The earpiece set of claim 13, wherein each microphone is fixedly coupled to a respective frame.

19. The earpiece set of claim 13 further comprising a pair of deformable bodies respectively coupled to the ear-insertion end of the frame, the deformable bodies adapted to substantially seal the respective ear canal.

20. The earpiece set of claim 13, wherein the power supply is housed in a respective frame.

21. A method for creating a binaural recording, the method comprising:
prompting a user, via a processor, to select a recording option on a touchscreen of a recorder, the recording option selected from the group consisting of recording audio, recording audio and video, broadcasting audio, and broadcasting audio and video;
receiving at least one gesture from the user on the touchscreen;
determining, via the processor, the selected recording option; and
causing, via the processor, the creation of at least one binaural recording using an earpiece set comprising a pair of earpieces each including a frame, a microphone, and a transducer, the frame adapted to be worn on an ear, the frame defining an ear-insertion end and a posterior end opposite the ear-insertion end, the ear-insertion end adapted to be positioned within an ear canal, the microphone coupled to the frame for capturing ambient sound, the microphone adapted to be positioned outside the ear canal and substantially coplanar with a tragus of the ear, the transducer coupled to the ear-insertion end of the frame, and the transducer configured to reproduce an incoming sound signal, at least one earpiece including a wireless transmitter coupled to the posterior end of the frame, the wireless transmitter configured to transmit outgoing data representative of the ambient sound and receive incoming data representative of the incoming sound signal, and at least one earpiece including a power supply electrically coupled to the microphones, the transducers, and the wireless transmitter.

22. A method for communicating a binaural recording, the method comprising:
receiving, at a server, a binaural recording created via a binaural recording system comprising a pair of earpieces each including a frame, a microphone, and a transducer, the frame adapted to be worn on an ear, the frame defining an ear-insertion end and a posterior end opposite the ear-insertion end, the ear-insertion end adapted to be positioned within an ear canal, the microphone coupled to the frame for capturing ambient sound, the microphone adapted to be positioned outside the ear canal and substantially coplanar with a tragus of the ear, the transducer coupled to the ear-insertion end of the frame, and the transducer configured to reproduce an incoming sound signal, at least one earpiece including a wireless transmitter coupled to the posterior end of the frame, the wireless transmitter configured to transmit outgoing data representative of the ambient sound and receive incoming data representative of the incoming sound signal, and at least one earpiece including a power supply electrically coupled to the microphones, the transducers, and the wireless transmitter, and a non-transitory device operatively coupled to the earpieces and having instructions thereon that are configured when executed to selectively operate the microphones and the transducers of the earpieces;
receiving a user election for transmission selected from the group consisting of transmitting the binaural recording to a user device, transmitting the binaural recording via email, and transmitting the binaural recording to a third-party service provider; and
responsive to the user election, transmitting the binaural recording.
